(19) United States
(12) Patent Application Publication
(10) Pub. No.: US 2004/0179618 A1
(43) Pub. Date: Sep. 16, 2004

(54) Smart loader video slicing method and system for using the same

(76) Inventors: Joseph N. Romriell, Alpine, UT (US); Matthew D. Cupal, Providence, UT (US); Michael Flathers, Alpine, UT (US)

Correspondence Address: TRASK BRITT, P.O. BOX 2550, SALT LAKE CITY, UT, 84110, US

(21) Appl. No.: 10/627,199

(22) Filed: Jul. 25, 2003

Related U.S. Application Data
(60) Provisional application No. 60/398,905, filed on Jul. 26, 2002.

(51) Int. Cl. H04N 7/12

(52) U.S. Cl. 375/240.26; 375/240.01

(57) ABSTRACT

A method and system that allows compression software to create longer playback of computer videos and provides additional user control. A set of one or more sliced video files is generated from a script that is configured to run independently of the one or more sliced video files. The script is further configured to facilitate playback control through loading of one or more of the sliced video files. A video is generated from the one or more sliced video files and a custom loader.

### FIELD OF THE INVENTION

The present invention relates generally to image compression techniques applicable to motion video. More specifically, the present invention includes a Smart Loader for video slicing and method and system for using sliced video.

### BACKGROUND OF THE INVENTION

The Internet has progressed from a fairly simple interactive text-based medium to one with increased graphics and interaction. Silent text has given way to compelling interactive media including full motion video. Many of these advances have come through industry standards, such as advances in hypertext markup language (HTML) and Java. Macromedia's Flash™ product is an example of a proprietary approach to interactive Internet media. Flash™ is owned by Macromedia, Inc. which is located in San Francisco, Calif., U.S.A. By some estimates, the Flash™ player is installed on 98% of computer systems connected to the Internet. Flash™ technology combines its strengths as an image handler (with strong vector-based graphics and animation) with a powerful scripting language that is coupled tightly with industry standards of extensible markup language (XML) and HTML.

Squeeze ™ is a video compression/decompression software which is owned by Sorenson Media, Inc. of Salt Lake City, Utah, which has further been integrated into the Macromedia Flash™ architecture. This recent version of Flash™ is known as Flash™ MX and allows for video support within the Flash™ architecture. Squeeze™ supports the creation of Flash™ video files that can be played back with the Flash™ embedded or standalone players. Squeeze™ extended the high quality video compression to Flash™ output formats.

While Flash™ MX has improved on the performance of Flash™ technology, there are limitations in the playback of video in Flash™ delivered via Macromedia Flash™ file format (SWF) files, particularly limiting the length of single file movie clips. More specifically, the Flash™ player loads the whole Flash™ SWF file into memory. Because of this, the allowable size of a SWF file played by the Flash™ player depends on available system memory. While desktop computer systems generally have enough memory to allow for approximately a 40MB-50MB SWF file to load and play, handhelds and other embedded devices, which support Flash™ , may have much less available memory. The Flash™ SWF format also limits the size of a single SWF video to 16000 frames. This limits the length a 30 fps video to about 8.9 minutes.

In order to overcome this limitation, Macromedia and others have developed a method of splitting a long video into what is called SWF video “slices.” These slices are loaded and played one after another in a stream. This method uses multiple files that are downloaded to create a single video stream. FIG. 1 illustrates a block diagram of slicing the long video file 10 into SWF “slices” 12-20. The idea is to break up the larger single video file into smaller separate files.

According to the conventional method, each slice would load and play in turn and, when completed, the next consecutive slice would play. Typically, a certain frame in the video called a “playhead” will cause the computer to download the next slice of video once that video frame is reached. This serial load and play architecture 22 is illustrated in the block diagram of FIG. 2. When a slice, for example, slice 24, is done playing, a subsequent slice, for example, slice 26, begins playing. The process continues until slices 28-32 have each completed. Although this conventional method works adequately in continuous playback from a local hard disk, there are several disadvantages with implementing this type of architecture.

While the conventional method allows for the playback of long video within Flash™, it has the following disadvantages: (1) over a slow bandwidth connection, there can be a serious playback disruption at the transition between slices 24-32; this occurs because a slice does not load the subsequent slice until it has nearly completed playing and time is required to download the next slice before the subsequent slice may be placed; (2) since the loading of the next slice is based on the playhead reaching a certain frame, it becomes extremely difficult to control the playhead based on user feedback, e.g., there may be a desire for a user to integrate play controls with other content to allow the user to generally move around in the video as stored in file 10 (FIG. 1), which the conventional method lacks; and (3) any type of dynamic advanced control that determines what part of the video should play and when is significantly limited.

Thus, there exists a need in the art for a new approach to video slicing that would allow support for longer video clips. It would be further advantageous to have a method and system that allows video compression to create SWF files in a manner that supports the playback of longer video within the player and overcomes the limitations of the prior art identified above.

### SUMMARY OF THE INVENTION

The present invention is a “Smart Loader” method and system that allows compression software to create sliced computer videos in a manner that supports the playback of longer video and gives the user more control than standard video players. One embodiment of the invention is a method for creating a set of one or more sliced video files by generating a script configured to run independently of one or more sliced video files, said script further configured to control playing and loading of one or more of said sliced video files.

Another exemplary embodiment of the invention is a system for slicing video, comprising a smart loader for selectively controlling video slicing by generating a control file, an automated compressor engine (ACE) in communication with the smart loader, where said ACE is configured for generating a set of video slices from a video source, and said ACE further configured to create a custom loader. The set of video slices are configured for generating a video based on the set of video slices and a custom loader, in accordance with the control file.

Another exemplary embodiment of the invention is a system for slicing video, comprising an automated compression engine (ACE) that uses a source video and a smart loader script to create a set of one or more video slices, wherein said set contains a custom scripted control file.

These embodiments of the present invention are not limiting and will be readily understood by one of ordinary skill in the art by reading the following detailed description in conjunction with the accompanying figures of the drawings.

### DESCRIPTION OF THE DRAWINGS

The drawings illustrate various views and embodiments for carrying out the present invention. Additionally, like reference numerals refer to like parts in different views or embodiments of the drawings.

FIG. 1 is a block diagram of a conventional slicing of a Flash™ video.

FIG. 2 is a block diagram of a conventional architecture for slicing a Flash™ video according to FIG. 1.

FIG. 3 is a block diagram of a Smart Loader in accordance with the present invention.

FIG. 4 is a block diagram of a system architecture according to the Smart Loader of the present invention.

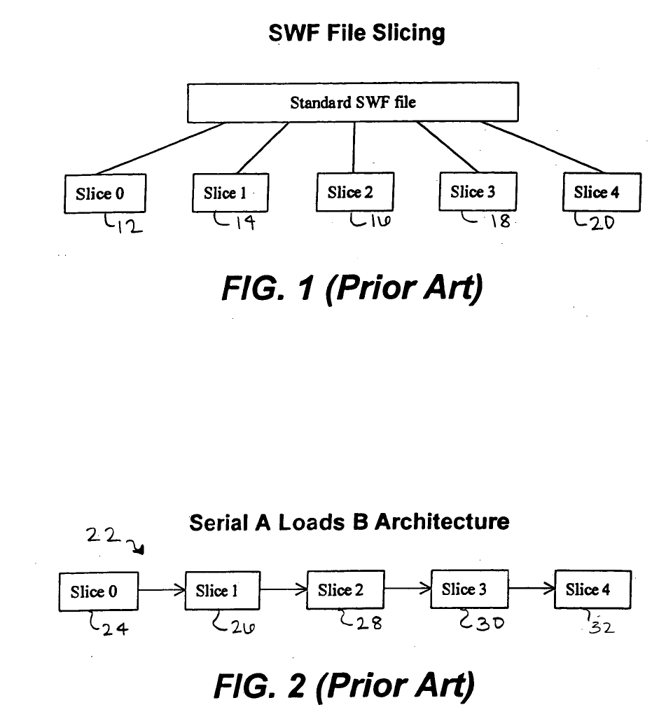

### DETAILED DESCRIPTION OF THE INVENTION

Embodiments of the present invention include a “Smart Loader” method and system that allows compression software to create sliced computer videos in a manner that supports the playback of longer video and gives the user more control than standard video players. In various embodiments of the invention, features of the Smart Loader of the present invention include: (1) the Smart Loader system which creates an automated method for generating video slices that overcome the memory and frame number limitations of sliced video files, for example Flash™ SWF files; (2) the Smart Loader may preload the slices independently at anytime, allowing the Smart Loader to have slices ready to play when the previous slice has finished and also providing a smooth transition from one slice to the next even over low bandwidth Internet connections; (3) the independence feature may allow the Smart Loader to make video loading decisions based on things like connection bandwidth and buffering models in order to play the video as smoothly and consistently as possible for the best possible user experience; (4) the control can be user configurable, instead of frame-based, the Smart Loader has complete control over which slice is playing and where it is playing within that slice, allowing for advanced controls such as fast forward, rewind, and generally seeking to locations in the video even if it crosses slice boundaries; and (5) the independence feature of the Smart Loader allows for deciding which slice to play next based on any defined criteria, which could be used for things such as changing the rating of a video based on the user profile by simply skipping a slice or playing a lower rated slice instead, and by allowing decisions to be made as to what to play based on how much a user has paid.

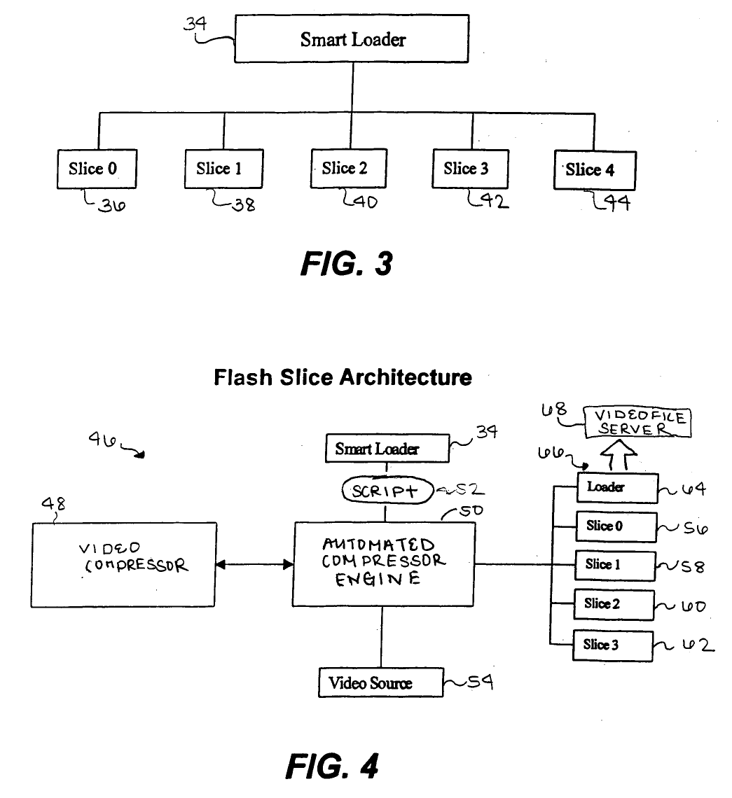

Embodiments of the present invention further include a Smart Loader method and system for creating, loading, controlling, and playing sliced computer video. The embodiments of the present invention may be incorporated with software such as, but is not limited to, Macromedia Flash™ video player, the specifications of which are herein incorporated by reference and available from Macromedia of San Francisco, Calif. The Flash™ architecture allows for the combination of vector graphics, images and video and further includes a scripting language that allows for advanced control over a Flash™ type video. An example of the scripting language includes ActionScript™ available from Macromedia, Inc. In one example, the Smart Loader 34 may be a Flash™ ActionScript™ type system that runs outside of the frame-based video illustrated as individual slices 36-44 as can be seen in FIG. 3. The slices 36-44 are each loaded individually at the control of the Smart Loader 34. This independence gives it several advantages over the conventional method of “A Loads B,” as depicted in the prior art of FIG. 2, including preloading slices 36-44 at any time. This allows the Smart Loader 34 to have subsequent slices ready to play when the previous slice has finished. This independence feature gives a smooth transition from one slice to the next, even over low bandwidth Internet connections. Another advantage of the Smart Loader 34 independence feature is that it can allow loading decisions based on connection bandwidth and buffering models in order to play the video as smoothly and consistently as possible for the best possible user experience.

One embodiment of the Smart Loader 34 of the present invention can include user controls such as but not limited to script language control, for example, ActionScript™ based control or the like. Since the control is script-based instead of frame-based, the Smart Loader 34 has complete control over which slice is playing and where it is playing within that slice. This Smart Loader 34 feature allows for advanced controls for play, stop, fast forward, rewind, go to start, go to end, and generally seeking to locations in the video, even if it crosses slice boundaries.

Yet another advantage of the of the independence feature of the Smart Loader 34 is deciding which slice 36-44 to play next based on any defined criteria. For instance, this may be used to change the rating of a video based on the user profile by simply skipping a slice or playing a lower rated slice. Decisions as to what to play may also be decided based on how much a user has paid. Of course, other advantages based on the advanced control feature of the Smart Loader of the present invention will be readily apparent to one of ordinary skill in the art.

The architecture of Flash™ or similar software, coupled with the Smart Loader technology, provide for a powerful method of video content control. The combination provides a clear advantage over conventional methods because of the ability to playback video slices and by providing a fundamental basis for advanced content selection.

FIG. 4 illustrates a block diagram of one embodiment of a system architecture 46 according to the Smart Loader 34 of the present invention. In this embodiment, video compressor software, for example, Squeeze™ software available from Sorenson Media, Inc., controls an Automated Compression Engine 50, an example of which is the ACE software available from Sorenson Media, Inc., which sets data (such as video) compression parameters and an output format of the video. ACE 50 can then take as input script 52, for example, an ActionScript™ that the Smart Loader 34 previously created with, for example, Flash™ MX and a video source 54, and generates SWF slices 56-62 and a custom loader 64 for that set of slices 56-62. Thereafter, those files 56-64 are referred to as an integrated set 66 and may optionally be uploaded to an automated video file server 68, such as but not limited to Vcast™ , also available from Sorenson Media, Inc. This integrated set 66 representing the original video can be played or broadcast by using a Smart Loader file as is known in the art.

Component modifications to the conventional method of Flash™ SWF type file slicing to support the Smart Loader of the present invention may include the following:

1. Video compression type software, an example of which is Squeeze™, may be modified to include user interface (UI) components to control the creation of the sliced SWF files 56-62.

2. The Smart Loader 34 may be written in, for example, ActionScript™ type software using Macromedia's Flash™ MX software and integrated with an Automated Compression Engine (ACE).

3. A SWF file format tool may be generated for inclusion in an ACE to dynamically modify the SWPF file to create a loader customized to the given frame rate, video dimensions, base name, number of slices, and the like.

4. The ACE 50 may be modified to support the slicing of the video based on input parameters.

5. Modifications may be made to the video file server 68, for example, a Vcast™ type component, in the ACE 50 to support the uploading of the integrated set 66 of SWV files 56-64. Each of these components is described in further detail below.

In one embodiment of the present invention, the ACE 50 includes slicing options for partitioning the video data. Exemplary slicing methods may include: (1) slicing based on file size (i.e., limit the size of each SWF file to that specified by the user); (2) slicing based on number of frames (i.e., only include the specified number of video frames in each slice); (3) slicing based on equal time increments (i.e., the user specifies a target time increment, e.g., 30 seconds and each slice is that long); and (4) slicing the files based on scene changes (i.e., create slices at what are determined to be scene change boundaries) and similar types of slicing.

The Smart Loader 34 may be a loading script which may be created using Flash™ MX and ActionScript™ type software, the specifications of which are available from the manufacturer and the programming of which is known by those of ordinary skill in the art. The generated SWF file containing the Smart Loader 34 is made available to the ACE 50 as an input. The ACE 50 may use a source video 54 and a Smart Loader script 52 to create a set of one or more Flash™ type video slices 56-62 that contain a custom scripted control file. Computer instructions or “code” may be written to allow the ACE 50 to customize the SWF file based on the specific parameters of the sliced set. An exemplary configuration of the Smart Loader 34 may further include:

1. A preloading mechanism (preloader) to facilitate smooth playback under a variety of network conditions. The preloader may be further configured to adapt to network characteristics by monitoring the effective bandwidth of the connected computer. Preloading of one or more Flash™ video files may adjust according to system or user input;

2. Single file preloading capability to prevent the playing of the video until enough of the file is downloaded to allow for the complete video to play without interruption;

3. An advanced “seeking” application program interface (API) to allow Flash™ or similar type developers to create video controls for their particular video. The Smart Loader of one embodiment of the present invention may also include automatic creation of these controls. Controls may include, but are not limited to include:

(a) “gotoStart” which may seek to the start of the movie or if the movie is in play mode, then the movie continues playing or if in stop mode, then seek to the beginning and then stop.

(b) “gotoEnd” which may seek to the end of the movie and stop.

(c) “fastForward” which may further include an input parameter indicating how many frames to step forward. The Smart Loader may then jump that many frames ahead even if it has to skip one or more slices to get there.

(d) “Rewind” which is similar to the fastForward function except that it jumps the requested number of frames backward in the video.

(e) “Play” which starts playing the video after it has been stopped.

(f) “Stop” which terminates playing the video.

(g) “Loop” which, when the video reaches the end, loops back to the start.

Since the Smart Loader 34, in one embodiment of the present invention, may be a precompiled SWF file, Smart Loader 34 may be customized to a particular video that will be played. Some examples of the particular parameters that may be customized include:

1. The Flash™ type stage size may be changed to the dimensions of the video.

2. The Flash™ type frame rate may be changed to the frame rate of the video.

3. The base name of the set of slices may be changed.

4. The number of slices may be given.

5. A frame rate parameter may be set.

Furthermore, the script 52, an example of which is an ActionScript™, may be generated offline with, for example, the Macromedia MX™ or similar type authoring tool. The SWF file that is generated may be modified to adjust the parameters described above or any other parameters. The SWF file may be searched and the contents changed according to those modifications with a new SWF file being generated which contains those modifications.

The ACE 50 may be modified such that if instructed to do so, the ACE 50 creates a set of files for which the sum of the parts represents the whole video. The ACE 50 may output the Loader 64 as the first file and each of the video segments as slices 56-62 numbered as, for example and not by way of limitation, “baseNameNUM” where NUM is the slice number from 0 to N−1, where N is an integer representing the total number of slices.

Additionally, by way of example, a component such as the Vcast™ type component in the ACE 50, may be modified with the ACE 50 being changed to properly support the uploading of multiple slices, in accordance with the Smart Loader 34 of the present invention. Vcasta™ type software may be modified to support the file set that contains the movie slices. Even when Vcast™ type software pushes the file set to a content delivery network (CDN), the file set remains at the same location for proper playback.

Additional embodiments of the Smart Loader 34 in accordance with embodiments of the present invention, may include one or more of the following:

1. A Smart Loader created using Flash™ type or similar software development kit (SDK) calls or direct script creation, rather than being written with Flash™ MX type or similar software and integrated as described herein.

2. A Smart Loader modified to dynamically change which slice loads from a set of different rate slices to dynamically adjust according to the user's bandwidth.

3. A Smart Loader modified to change which slice is loaded next depending on things such as ratings, how much a user has paid, or any other suitable criteria. This modification decision may be dynamically changed based on user or server input.

4. A Smart Loader adaptable to use various bandwidth, total SWF file length, or other suitable criteria in order to change how many slices are preloaded.

5. A Smart Loader integrated with Flash™ or similar type templates to provide video player controls or other integrated Flash™ or similar type controls, Flash™ type look and feel, or other Flash™ type features which may be further automated.

While various embodiments have been described with some embodiments directed to include commercially available components, the invention is not so limiting. Furthermore, the specifications of the commercially available components have not been exhaustively described herein as the specifications are readily available from their respective manufacturers and are further appreciated by those of ordinary skill in the art.

Although this invention has been described with reference to particular embodiments, the invention is not limited to these described embodiments. Rather, the invention is limited only by the appended claims, which include within their scope all equivalent devices or methods that operate according to the principles of the invention as described herein.

What is claimed is:

1. A method for creating a set of one or more sliced video files, comprising:
generating a script configured to run independently of said one or more sliced video files, said script further configured to control playing and loading of said one or more sliced video files; and
slicing video data into said one or more sliced video files according to a parameter of said script.

2. The method of claim 1, further comprising preloading said one or more sliced video files.

3. The method of claim 1, further comprising adaptively loading said one or more sliced video files according to effective bandwidth.

4. The method of claim 1, further comprising selectively playing said one or more sliced video files according to a video rating parameter.

5. The method of claim 1, further comprising selectively playing said one or more sliced video files according to a user rating parameter.

6. The method of claim 1, further comprising selectively playing said one or more sliced video files according to a user payment parameter.

7. A system for slicing video, comprising:
a smart loader for selectively controlling video slicing; and
an automated compression engine (ACE) in communication with said smart loader, said ACE configured for generating a set of video slices from a video source, said ACE further configured to create a custom loader, said set of video slices configured for generating a video based on said set of video slices and said custom loader.

8. The system of claim 7, further comprising a video compressor in communication with said ACE, said compressor configured for compressing a source video.

9. The system of claim 7, further comprising an automated video file server for broadcasting said video.

10. The system of claim 7, further configured for playing said video slices consecutively without interruption.

11. The system of claim 7, further configured to allow a user to seek a specific location in said video slices.

12. The system of claim 7, further configured to load said video slices independently from one another.

13. A system for slicing video, comprising:
a smart loader script and source video; and
an automated compression engine (ACE) configured to use said source video and said smart loader script to create a set of one or more video slices, wherein said set contains a custom loader.

14. The system of claim 13, wherein said custom loader is merged with said one or more video slices.

15. The system of claim 13, wherein said smart loader script is created by said automated compression engine.

16. The system of claim 13, further comprising a video compressor in communication with said automated compression engine, said compressor configured for compressing said source video.

17. The system of claim 13, further comprising an automated video file server for broadcasting output video.

18. The system of claim 13, wherein said custom loader is user configurable.

19. The system of claim 13, further configured for playing said one or more video slices consecutively without interruption.

20. The system of claim 13, further configured to allow a user to seek a specific location in said one or more video slices.

21. The system of claim 13, further configured to load said one or more video slices independently from one another.
